(19) United States
(12) Patent Application Publication
(10) Pub. No.: US 2018/0096267 A1
(43) Pub. Date: Apr. 5, 2018

(54) SINGLE MODEL-BASED BEHAVIOR PREDICTIONS IN AN ON-DEMAND ENVIRONMENT

(71) Applicant: salesforce.com, inc., SAN FRANCISCO, CA (US)

(72) Inventors: Chalenge Masekera, San Francisco, CA (US); Vitaly Gordon, Sunnyvale, CA (US); Leah McGuire, Redwood City, CA (US); Shubha Nabar, Sunnyvale, CA (US)

(21) Appl. No.: 15/712,911

(22) Filed: Sep. 22, 2017

Related U.S. Application Data
(60) Provisional application No. 62/402,899, filed on Sep. 30, 2016.

(51) Int. Cl. G06Q 10/06; G06N 5/04; G06N 99/00; G06Q 10/08; G06Q 10/04; G06Q 30/02

(52) U.S. Cl. CPC G06Q 10/06; G06N 5/04; G06N 99/005; G06F 17/30; G06Q 10/04; G06Q 30/0201; G06Q 10/08

(57) ABSTRACT

In accordance with embodiments, there are provided mechanisms and methods for facilitating single model-based behavior predictions in an on-demand services environment in an on-demand services environment according to one embodiment. In one embodiment and by way of example, a method comprises collecting, by a model selection and application server device (“model device”), information associated with customers of a tenant, and extracting, from the information, behavior traits of the customers as they relate to products or services offered by the tenant. The method further includes dynamically selecting, by the model device, a single model from a set of models to convert the behavior traits into predictions indicating anticipated conduct of each customer in relation to one or more products or one or more of the services of the tenant, where the single model performs multiple processes to convert the behavior traits into predictions, and where the multiple processes include at least two of the following: evaluating data, cleansing the data, transforming the data. The method may further include writing the data, and transmitting, over a communication medium, the predictions to the tenant.

### CLAIM OF PRIORITY

This application is a continuation of U.S. Provisional Application No. 62/402,899 by Chalenge Masekera, et al., filed Sep. 30, 2016, the benefit of and priority to which are claimed thereof and the contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to data management; more specifically, to facilitating single model-based behavior predictions in an on-demand services environment.

### BACKGROUND

Conventional techniques require multiple models to perform multiple processes, such as a single model may only be suited to perform a single task, such as data prediction. Stated differently, in conventional systems, several models are required to be generated, trained, and used to perform their corresponding processes which, in turn, requires employing dedicated individuals, such as data scientists, software developers, etc., to build and tune such models. This is resource-consuming, cumbersome, and prone to human error.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The secure and efficient retrieval of accurate information and subsequent delivery of this information to the user system has been and continues to be a goal of administrators of database systems. Unfortunately, conventional database approaches are associated with various limitations.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a system having a computing device employing a single model-based behavior predictions mechanism according to one embodiment.

FIG. 2 illustrates the single model-based behavior predictions mechanism of FIG. 1 according to one embodiment.

FIG. 3A illustrates a transaction sequence for facilitating production and selection of models for generating predictions according to one embodiment.

FIG. 3B illustrates a transaction sequence for facilitating transformation according to one embodiment.

FIG. 3C illustrates a transaction sequence for facilitating production and selection of models for generating predictions according to one embodiment.

FIG. 3D illustrates a transaction sequence for facilitating production and selection of models for generating predictions according to one embodiment.

FIG. 3E illustrates a workflow with features according to one embodiment.

FIG. 4 illustrates a method for facilitating production and selection of models for generating predictions according to one embodiment.

FIG. 5 illustrates a computer system according to one embodiment.

FIG. 6 illustrates an environment wherein an on-demand database service might be used according to one embodiment.

FIG. 7 illustrates elements of environment of FIG. 6 and various possible interconnections between these elements according to one embodiment.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Embodiments provide for a novel technique for quicker modeling turnarounds and higher accuracy by allowing for dynamic selection of a single model that is capable of accessing and using any libraries to perform multiple operations for all customers of a tenant as they relate to their products and/or services. Subsequently, predictions of each customer's anticipated behavior towards the tenant's products and services may be offered to the tenant.

In one embodiment, smart machine learning models may be generated and trained or tuned to perform various processors for all customers of a tenant, where performing processes includes collecting data, extracting behavior traits, transforming or converting behavior traits into predictions, selecting models, writing data, etc. It is contemplated that throughout this document, models include or refer to machine learning models.

It is contemplated that embodiments and their implementations are not merely limited to multi-tenant database system (“MTDBS”) and can be used in other environments, such as a client-server system, a mobile device, a personal computer (“PC”), a web services environment, etc. However, for the sake of brevity and clarity, throughout this document, embodiments are described with respect to a multi-tenant database system, such as Salesforce.com®, which is to be regarded as an example of an on-demand services environment. Other on-demand services environments include Salesforce® Exact Target Marketing Cloud™.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

In one embodiment, a multi-tenant database system utilizes tenant identifiers (IDs) within a multi-tenant environment to allow individual tenants to access their data while preserving the integrity of other tenant's data. In one embodiment, the multitenant database stores data for multiple client entities each identified by a tenant ID having one or more users associated with the tenant ID. Users of each of multiple client entities can only access data identified by a tenant ID associated with their respective client entity. In one embodiment, the multitenant database is a hosted database provided by an entity separate from the client entities, and provides on-demand and/or real-time database service to the client entities.

A tenant includes a group of users who share a common access with specific privileges to a software instance. A multi-tenant architecture provides a tenant with a dedicated share of the software instance typically including one or more of tenant specific data, user management, tenant-specific functionality, configuration, customizations, non-functional properties, associated applications, etc. Multi-tenancy contrasts with multi-instance architectures, where separate software instances operate on behalf of different tenants.

Embodiments are described with reference to an embodiment in which techniques for facilitating management of data in an on-demand services environment are implemented in a system having an application server providing a front end for an on-demand database service capable of supporting multiple tenants, embodiments are not limited to multi-tenant databases nor deployment on application servers. Embodiments may be practiced using other database architectures, i.e., ORACLE®, DB2® by IBM and the like without departing from the scope of the embodiments claimed.

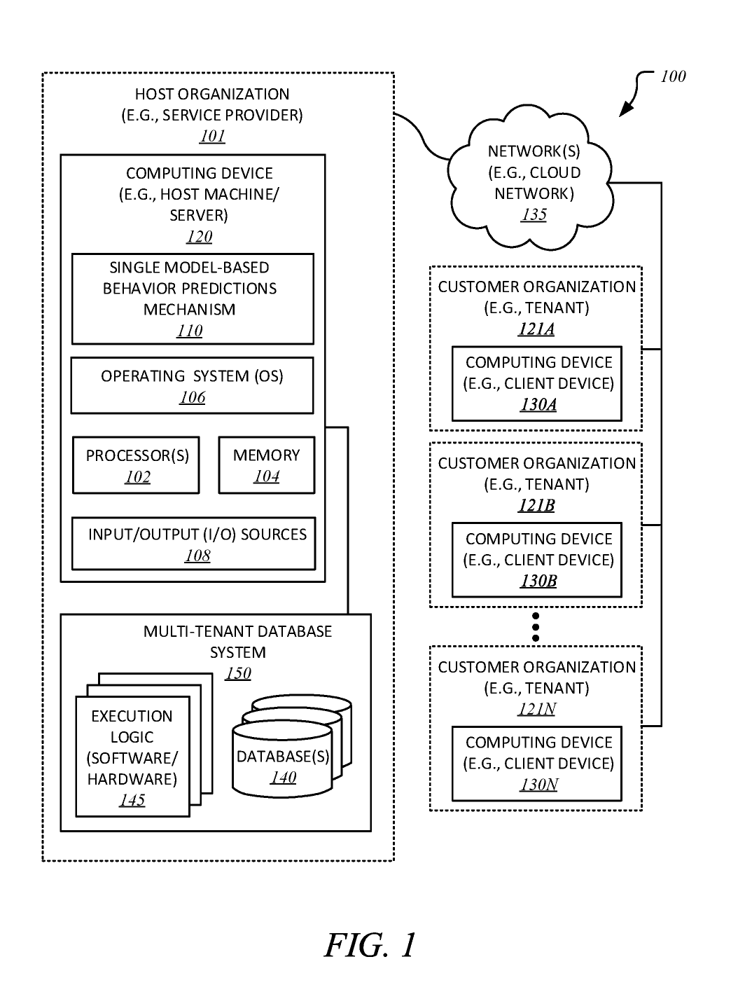

FIG. 1 illustrates a system 100 having a computing device 120 employing a single model-based behavior predictions mechanism (“model-predictions mechanism”) 110 according to one embodiment. As illustrated, in one embodiment, computing device 120, being part of host organization 101 (e.g., service provider, such as Salesforce.com®), represents or includes a server computer acting as a host machine for employing prediction mechanism 110 for facilitating smart deployment of metadata packages in a multi-tiered, multi-tenant, on-demand services environment.

It is to be noted that terms like “queue message”, “job”, “query”, “request” or simply “message” may be referenced interchangeably and similarly, terms like “job types”, “message types”, “query type”, and “request type” may be referenced interchangeably throughout this document. It is to be further noted that messages may be associated with one or more message types, which may relate to or be associated with one or more customer organizations, such as customer organizations 121A-121N, where, as aforementioned, throughout this document, “customer organizations” may be referred to as “tenants”, “customers”, or simply “organizations”. An organization, for example, may include or refer to (without limitation) a business (e.g., small business, big business, etc.), a company, a corporation, a non-profit entity, an institution (e.g., educational institution), an agency (e.g., government agency), etc.), etc., serving as a customer or client of host organization 101 (also referred to as “service provider” or simply “host”), such as Salesforce.com®, serving as a host of model-predictions mechanism 110.

Similarly, the term “user” may refer to a system user, such as (without limitation) a software/application developer, a system administrator, a database administrator, an information technology professional, a program manager, product manager, etc. The term “user” may further refer to an end-user, such as (without limitation) one or more of customer organizations 121A-N and/or their representatives (e.g., individuals or groups working on behalf of one or more of customer organizations 121A-N), such as a salesperson, a sales manager, a product manager, an accountant, a director, an owner, a president, a system administrator, a computer programmer, an information technology (“IT”) representative, etc.

Computing device 120 may include (without limitation) server computers (e.g., cloud server computers, etc.), desktop computers, cluster-based computers, set-top boxes (e.g., Internet-based cable television set-top boxes, etc.), etc. Computing device 120 includes an operating system (“OS”) 106 serving as an interface between one or more hardware/physical resources of computing device 120 and one or more client devices 130A-130N, etc. Computing device 120 further includes processor(s) 102, memory 104, input/output (“I/O”) sources 108, such as touchscreens, touch panels, touch pads, virtual or regular keyboards, virtual or regular mice, etc.

In one embodiment, host organization 101 may further employ a production environment that is communicably interfaced with client devices 130A-N through host organization 101. Client devices 130A-N may include (without limitation) customer organization-based server computers, desktop computers, laptop computers, mobile computing devices, such as smartphones, tablet computers, personal digital assistants, e-readers, media Internet devices, smart televisions, television platforms, wearable devices (e.g., glasses, watches, bracelets, smartcards, jewelry, clothing items, etc.), media players, global positioning system-based navigation systems, cable setup boxes, etc.

In one embodiment, the illustrated multi-tenant database system 150 includes database(s) 140 to store (without limitation) information, relational tables, datasets, and underlying database records having tenant and user data therein on behalf of customer organizations 121A-N (e.g., tenants of multi-tenant database system 150 or their affiliated users). In alternative embodiments, a client-server computing architecture may be utilized in place of multi-tenant database system 150, or alternatively, a computing grid, or a pool of work servers, or some combination of hosted computing architectures may be utilized to carry out the computational workload and processing that is expected of host organization 101.

The illustrated multi-tenant database system 150 is shown to include one or more of underlying hardware, software, and logic elements 145 that implement, for example, database functionality and a code execution environment within host organization 101. In accordance with one embodiment, multi-tenant database system 150 further implements databases 140 to service database queries and other data interactions with the databases 140. In one embodiment, hardware, software, and logic elements 145 of multi-tenant database system 130 and its other elements, such as a distributed file store, a query interface, etc., may be separate and distinct from customer organizations (121A-121N) which utilize the services provided by host organization 101 by communicably interfacing with host organization 101 via network(s) 135 (e.g., cloud network, the Internet, etc.). In such a way, host organization 101 may implement on-demand services, on-demand database services, cloud computing services, etc., to subscribing customer organizations 121A-121N.

In some embodiments, host organization 101 receives input and other requests from a plurality of customer organizations 121A-N over one or more networks 135; for example, incoming search queries, database queries, application programming interface (“API”) requests, interactions with displayed graphical user interfaces and displays at client devices 130A-N, or other inputs may be received from customer organizations 121A-N to be processed against multi-tenant database system 150 as queries via a query interface and stored at a distributed file store, pursuant to which results are then returned to an originator or requestor, such as a user of client devices 130A-N at any of customer organizations 121A-N.

As aforementioned, in one embodiment, each customer organization 121A-N is an entity selected from a group consisting of a separate and distinct remote organization, an organizational group within host organization 101, a business partner of host organization 101, a customer organization 121A-N that subscribes to cloud computing services provided by host organization 101, etc.

In one embodiment, requests are received at, or submitted to, a web server within host organization 101. Host organization 101 may receive a variety of requests for processing by host organization 101 and its multi-tenant database system 150. For example, incoming requests received at the web server may specify which services from host organization 101 are to be provided, such as query requests, search request, status requests, database transactions, graphical user interface requests and interactions, processing requests to retrieve, update, or store data on behalf of one of customer organizations 121A-N, code execution requests, and so forth. Further, the web-server at host organization 101 may be responsible for receiving requests from various customer organizations 121A-N via network(s) 135 on behalf of the query interface and for providing a web-based interface or other graphical displays to one or more end-user client devices 130A-N or machines originating such data requests.

Further, host organization 101 may implement a request interface via the web server or as a stand-alone interface to receive requests packets or other requests from the client devices 130A-N. The request interface may further support the return of response packets or other replies and responses in an outgoing direction from host organization 101 to one or more client devices 130A-N.

It is to be noted that any references to software codes, data and/or metadata (e.g., Customer Relationship Model (“CRM”) data and/or metadata, etc.), tables (e.g., custom object table, unified index tables, description tables, etc.), computing devices (e.g., server computers, desktop computers, mobile computers, such as tablet computers, smartphones, etc.), software development languages, applications, and/or development tools or kits (e.g., Force.com®, Force.com Apex™ code, JavaScript™, jQuery™, Developerforce™, Visualforce™, Service Cloud Console Integration Toolkit (“Integration Toolkit” or “Toolkit”), Platform on a Service™ (“PaaS”), Chatter® Groups, Sprint Planner®, MS Project®, etc.), domains (e.g., Google®, Facebook®, LinkedIn®, Skype®, etc.), etc., discussed in this document are merely used as examples for brevity, clarity, and ease of understanding and that embodiments are not limited to any particular number or type of data, metadata, tables, computing devices, techniques, programming languages, software applications, software development tools/kits, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, “multi-tenant on-demand data system”, and the like, may be used interchangeably throughout this document. It is to be further noted that terms like “code”, “software code”, “application”, “software application”, “program”, “software program”, “package”, “software code”, “code”, and “software package” may be used interchangeably throughout this document. Moreover, terms like “job”, “input”, “request”, and “message” may be used interchangeably throughout this document.

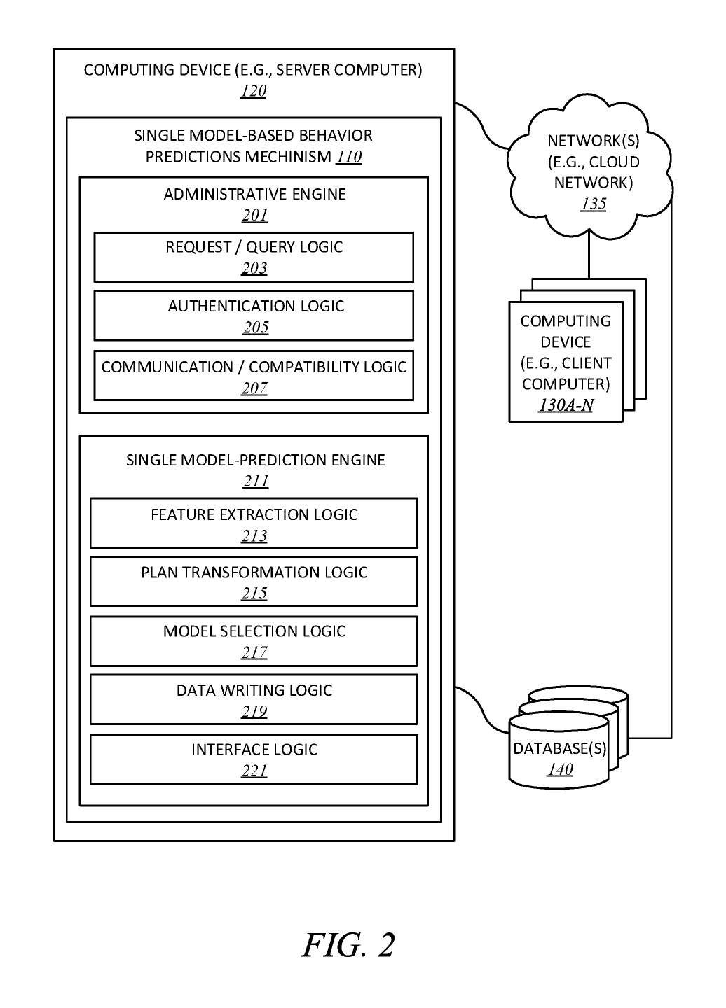

FIG. 2 illustrates model-predictions mechanism 110 of FIG. 1 according to one embodiment. In one embodiment, prediction mechanism 110 may include any number and type of components, such as administration engine 201 having (without limitation): request/query logic 203; authentication logic 205; and communication/compatibility logic 207. Similarly, model-predictions mechanism 110 may further include single model-prediction engine (“prediction engine”) 211 including (without limitation): feature extraction logic 213; plan transformation logic 215; model selection logic 217; data writing logic 219; and interface logic 221.

In one embodiment, computing device 120 may serve as a service provider core (e.g., Salesforce.com® core) for hosting and maintaining prediction mechanism 110 and be in communication with one or more database(s) 140, one or more client computer(s) 130A-N, over one or more network(s) 135, and any number and type of dedicated nodes.

Throughout this document, terms like “framework”, “mechanism”, “engine”, “logic”, “component”, “module”, “tool”, and “builder” may be referenced interchangeably and include, by way of example, software, hardware, and/or any combination of software and hardware, such as firmware. Further, any use of a particular brand, word, or term, such as “metadata”, “metadata package”, “deployment”, “deployment cost”, “characteristics”, “criteria”, “cost criteria”, “cost engine”, “matching”, “comparing”, “evaluating”, “analyzing”, “profiling”, “selecting”, “deciding”, “routing”, “generating”, “maintaining”, “routes”, “paths”, “queues”, “queuing”, “enqueuing”, “dequeuing”, “query failure”, “latency”, “predictability”, “time frame”, “size”, “customization”, “testing”, “updating”, “upgrading”, etc., should not be read to limit embodiments to software or devices that carry that label in products or in literature external to this document.

As aforementioned, with respect to FIG. 1, any number and type of requests and/or queries may be received at or submitted to request/query logic 203 for processing. For example, incoming requests may specify which services from computing device 120 are to be provided, such as query requests, search request, status requests, database transactions, graphical user interface requests and interactions, processing requests to retrieve, update, or store data, etc., on behalf of one or more client device(s) 130A-N, code execution requests, and so forth.

In one embodiment, computing device 120 may implement request/query logic 203 to serve as a request/query interface via a web server or as a stand-alone interface to receive requests packets or other requests from the client device(s) 130A-N. The request interface may further support the return of response packets or other replies and responses in an outgoing direction from computing device 120 to one or more client device(s) 130A-N.

Similarly, request/query logic 203 may serve as a query interface to provide additional functionalities to pass queries from, for example, a web service into the multi-tenant database system for execution against database(s) 140 and retrieval of customer data and stored records without the involvement of the multi-tenant database system or for processing search queries via the multi-tenant database system, as well as for the retrieval and processing of data maintained by other available data stores of the host organization's production environment. Further, authentication logic 205 may operate on behalf of the host organization, via computing device 120, to verify, authenticate, and authorize, user credentials associated with users attempting to gain access to the host organization via one or more client device(s) 130A-N.

In one embodiment, computing device 120 may include a server computer which may be further in communication with one or more databases or storage repositories, such as database(s) 140, which may be located locally or remotely over one or more networks, such as network(s) 235 (e.g., cloud network, Internet, proximity network, intranet, Internet of Things (“IoT”), Cloud of Things (“CoT”), etc.). Computing device 120 is further shown to be in communication with any number and type of other computing devices, such as client computing devices) 130A-N, over one or more communication mediums, such as network(s) 140.

As previously discussed, traditional machine learning may involve a series of processes and as such conventional techniques require multiple models (“models”) (e.g., machine learning models) to perform multiple processes because a single model can only perform a single process or task. In other words, in conventional systems, machine learnt models are built for a single use-case scenario or application and thus is only useful for that one use-case scenario. Consequently, using conventional techniques, multiple models are required to be generated, trained, fine-tuned, and applied or executed to be used for performing multiple processes.

Embodiments provide for novel technique, as facilitated by prediction mechanism 110, for generating, training, and tuning a single model to perform any number and type of processes, such as (but not limited to) data collection or extraction, data cleansing, data evaluation, data transformation to suit the needs of a user or a tenant, automatic and dynamic selection of a suitable single model, deployment of the selected model, and/or the like. Further, this novel technique eliminates the need for testing and trying out of a bunch of models as is typically done with conventional systems.

For example, a tenant, such as an e-commerce company, may wish to build a recommender application that predicts the likelihood of this customers and/or potential customers to be interested in purchasing the company's products and/or services. In this case, since most customers that visit the e-commerce website may use the website in a similar manner (such as for searching for terms that appear in the description of products and/or services they might be interested in purchasing, visiting the pages for other similar products and/or services, viewing a product/service page multiple times before making a purchase, etc.).

In one embodiment, purchasing mechanism 110 provides for a novel technique for building a single machine learning model that generalizes data using behavior of all customers of the tenant to generate accurate predictions for each of the customers. These predictions may then be communicated on to the tenant so they may know and plan, build, or modify their business model accordingly and further, allow the tenant to be proactive and have their team of data scientists, software developers, etc., build and match models for specific predictive use cases prior to needing such models.

For example, in the case of service/environment providers (e.g., Salesforce.com® or other Software as a Service (SaaS) companies, etc.), with customizable platforms, each tenant may use the platform offered by the providers in a different matter than other tenants, such as in a way that is tuned to their particular products, services, sales, and marketing processes and plans. Further, due to privacy concerns and depending on the nature of the tenant's business, cross-pollination of data between different customers may not be possible or desired and thus, a unique personalized model per customer may be necessitated or desired.

For example, in a scenario when a customer relationship management (CRM) provider, such as Salesforce.com®, may wish to build an application that predicts the likelihood for sales leads to convert for its tenants. The stages that a lead goes through, such as from the point of entering the system up until the point when the sales lead converts, may vary from tenant to tenant and thus the rate of conversion may be different for from tenant to tenant, such as the average length of time that a conversion takes may be different for each tenant. With conventional techniques, this could mean generating thousands of models to be able to accommodate all their customers.

Embodiments provide for a highly scalable framework, as facilitated by prediction mechanism 110, for teaching machines to perform machine learning, while automating several of the tasks that would typically be performed by a data scientist on a day-to-day basis. In some embodiments, the framework provides processes for (but not limited to) one or more automatic feature generation, automatic feature transformation (including missing value computation), smart binning, feature normalization, interaction features, automated removal of highly correlated features to prevent label leakage, automated rebalancing of unbalanced training data, automated hyper parameter tuning and optimization, automated model selection and/or automatic calibration of predictive scores.

In one embodiment, the novel techniques are architectures described herein may provide, for example, quicker turnarounds and higher accuracy than general purpose modeling libraries and for any given predictive application, it may build personalized models for individual customers or clients of tenants.

In general, machine learning involves the use of algorithms to decide how to perform tasks by generalizing from examples. This may be feasible and cost-effective in situations where custom manual programming is not; however, developing successful machine learning applications may necessitate substantial knowledge and background work. For example, machine learning utilizes generalized examples, so a machine learning algorithm may not be blindly applied to raw data and provide sufficient results. Different types of problems may necessitate different type of machine learning techniques and before applying machine learning techniques, the data to be analyzed is cleaned (e.g., “bad” data is removed) and manipulated so that the most predictive features are available and put into the correct or expected format.

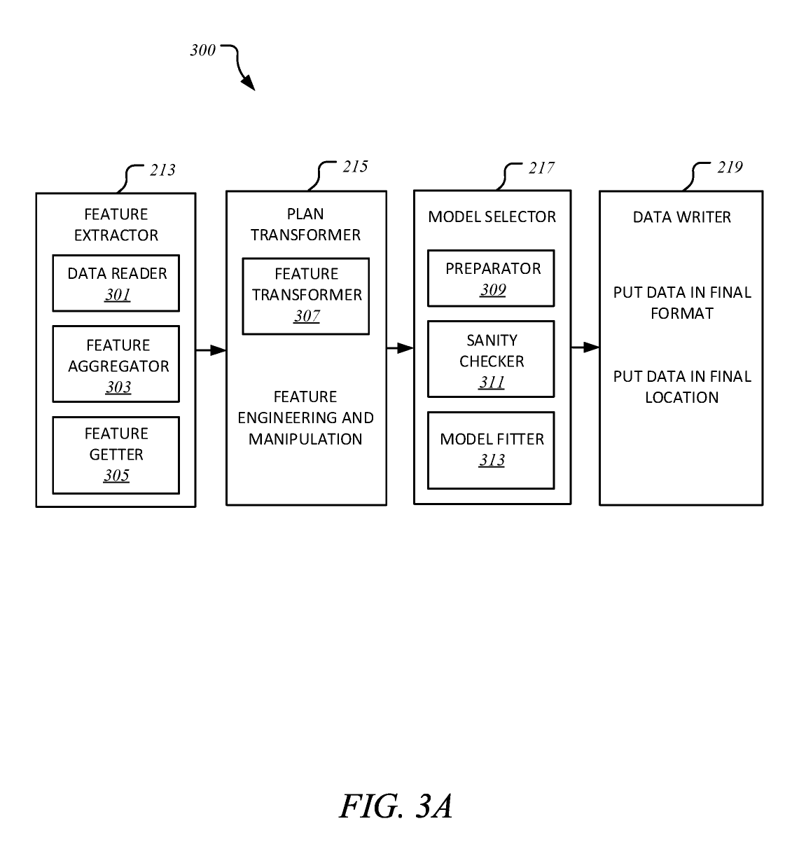

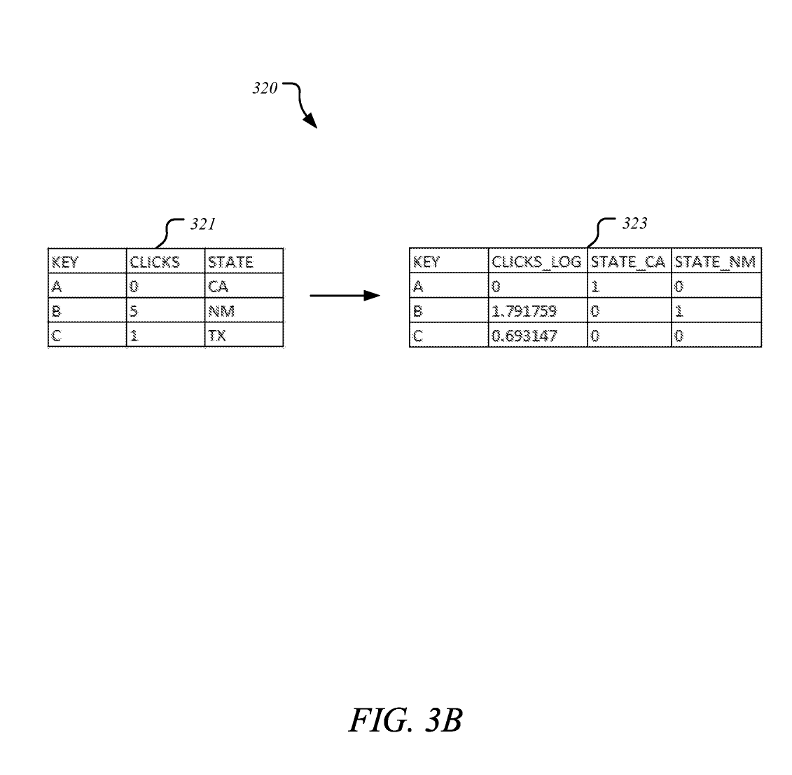

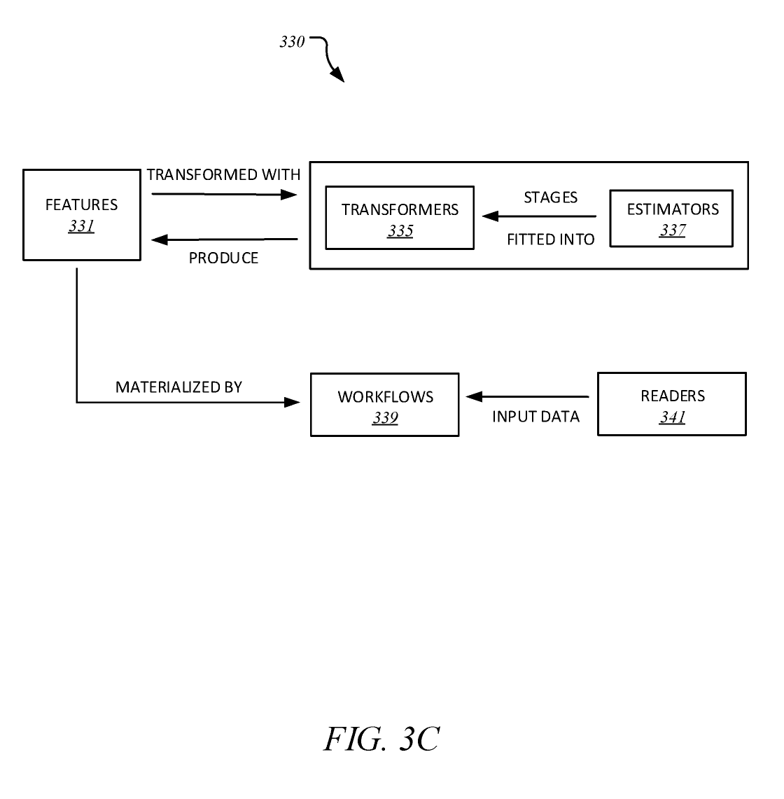

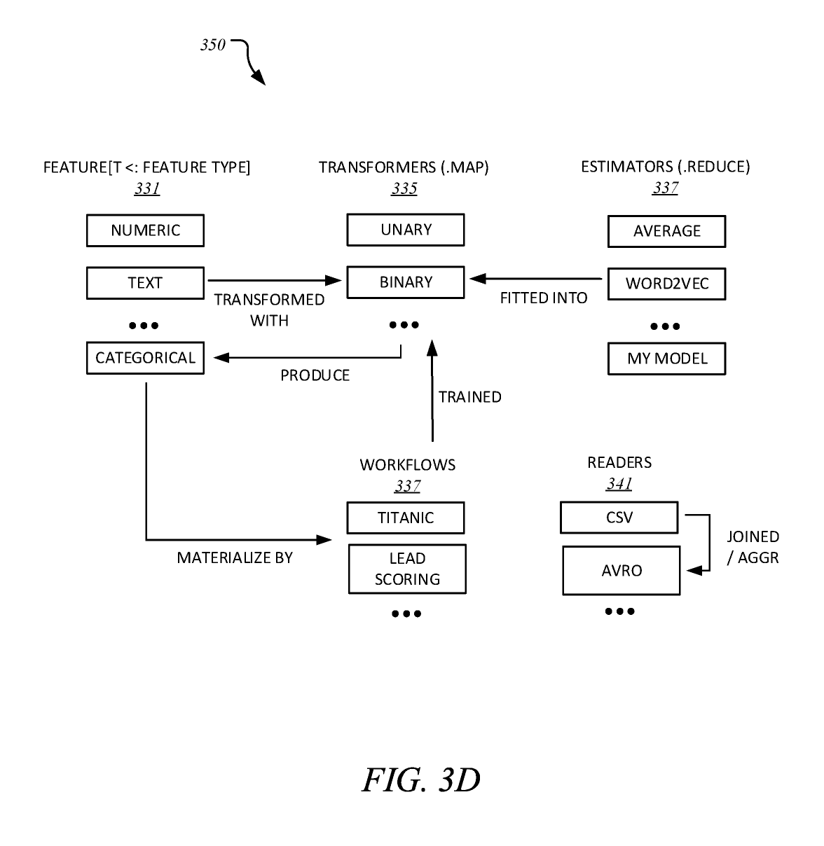

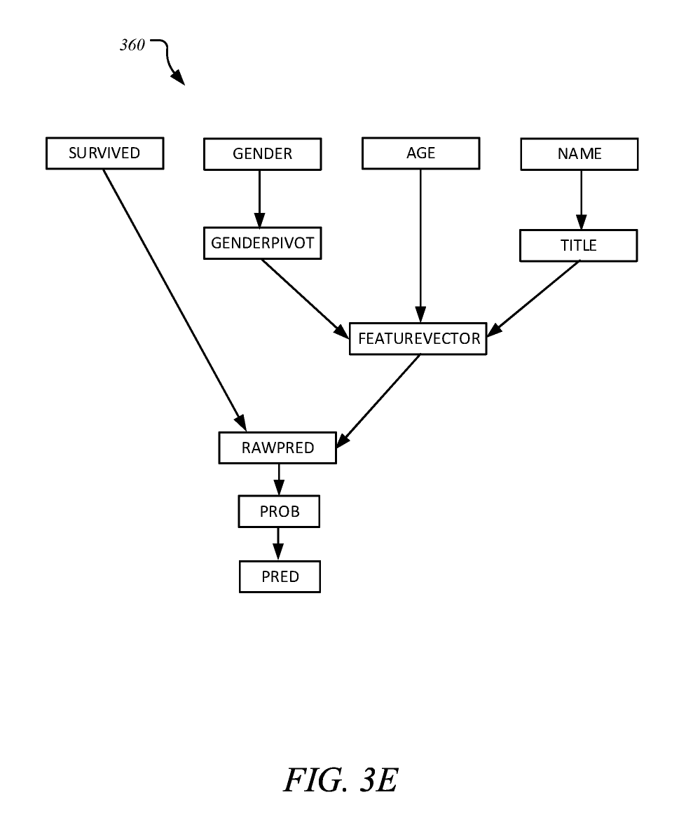

In one embodiment, prediction mechanism 110 provides feature extraction logic 213 to access and extract any relevant data from one or more of database(s) 140 through data reader, feature aggregator, and feature getter, as further described with reference to FIG. 3A. In one embodiment, feature extraction logic 213 (also referred to as “feature extractor”) to collect or extract or gather any relevant data relating to customers of tenants from one or more database(s) 140.

For example, there may be any amount and type of data relating to customers, ranging from their names and addresses to their habits and interests with regard to products and/or services offered by one or more tenants, and/or the like. In one embodiment, feature extractor 213 may facilitate the data reader to access and/or read any relevant data that offers or represents customers behavior traits (such as customers' interest in certain products and/or services offered by a tenant, etc.) from one or more database(s) 140, where, in one embodiment, this accessed and read data is then feature aggregated by the feature aggregator. For example, feature aggregation may include organizing and separating of data by customers, time, product and/or services, etc., along with extracting certain facts, habits, customs, etc., associated with customers, products, services, etc.

Once this feature data is aggregated by feature aggregator, in one embodiment, feature extractor 213 may facilitate the feature getter to then extract certain relevant or interesting features from the feature aggregated data. For example, feature information including behavior trait like a customer may be known for ordering the same product every month may be extracted by feature getter so that this customer may be considered and possibly encouraged by the tenant to sign up for an automatic payment and delivery of the product. Similarly, for example, feature information including behavior trait like another customer of the tenant having a habit of checking out the same webpage several times prior to ordering a product and/or service may be extracted so that this customer may be offered a time-sensitive coupon, free shipping, etc., or offer other products along with the product of interest on the same web page to expedite the transaction and/or sell additional products and/or services.

This extracted feature-based information or data is then forwarded onto plan transformation logic 215 (also referred to as “transformer” or “plan transformer” or interchangeably “feature transformer”) for further processing. In one embodiment, transformer 215 may facilitate a feature transformer, as illustrated in FIG. 3A, to perform feature engineering and manipulation to generate transformation plans based on the extracted feature-based data. In one embodiment, extracted feature-based information is then converted into specific predictions by transformer 215, where, for example, behavior traits of customers based on extracted feature-based data may be transformed or changed into predictions by transformer 215. For example, as described above, a customer's behavior trait of buying the same product or service month-after-month can be transformed into a prediction that the customer is likely to continue to act according to the behavior trait, where this transformation is facilitated by transformer 215.

In one embodiment, transformer 215 may be further used for checking on data (such as telephone number, valid emails, etc.) to determine whether the data or behavior traits are predicable or, in other words, convertible into predictions. As will be further discussed later, for example, any predictions relating to customers of a tenant generated by the single model may then be transmitted on to the tenant through one or more client computing devices 130A-N over one or more networks 135 (e.g., cloud network) as facilitated by communication/compatibility logic 207.

Further, in one embodiment, interface logic 221 may be used to offer one or more interfaces or interfacing capability at one or more client computing devices 130A-N to allow the users (e.g., sales agents, marketing people, software developers, data scientists, etc.) representing the tenants to review the single model and use it to generate and view any predictions concerning their customers in relation to their products and/or services. This, for example, allows for the users to come up with expectation and/or plans to improve their business plans, marketing approach, etc., towards their existing and/or potential customers to increase the sale of the products and/or services.

Now referring back to transformer 215, once the data is transformed to be ready for predictions, it is then forwarded on to model selection logic 217 to perform its processes to select the most fitting and convenience model (e.g., machine learning model) for the tenant to use to access, understand, and use the predictions as described above. For example, as illustrated with regard to FIG. 3A, model selection logic (also referred to as “model selector”) 217 may contain and/or facilitate a number of components, such as preparator, sanity checker, and model fitter, etc., to perform a number of tasks relating to selection of the most fitted model for the tenant.

In one embodiment, model selector 217 may facilitate the preparator to prepare the predictions or prediction data, such as organize the data for sanity checker to check the data to ensure it is ready to be communicated with the tenant. In one embodiment, model selector 217 may be used to facilitate sanity checker to cleanse the data by checking all the predictions and any other related data to ensure that all data is (but not limited to) accurate and current (e.g., customer information is correct, product information is current, etc.), does not violate any privacy issues (e.g., discloses any information about customers that might be regarded as private or inappropriate), and capable for being communicated, such as it does not include any information that might be regarded as illegal or unethical (such as incitement to violence, etc.), and/or the like. In one embodiment, sanity checker performs data cleansing as part of a model so this too can be performed by the same (single) model.

Upon checking the sanity of predictions and any other relevant data, model selector 217 may facilitate the fit model component to select and fit the best model for the tenant with regard to the predictions about their customers. In one embodiment, model selector 217 selects a single model to generalize all the relevant data (e.g., behavior traits, predictions, etc.) about all the customers of the tenant such all the predictions about all the customers of the tenant are provided using the single model.

In one embodiment, prior to sending out the selected model to the tenant, where the model is capable of making and offering predictions to customers' tenants, data writing logic (also referred to as “data writer”) 219 prepares to convert the model and any relevant data in its final format final format and place the final formatted data in a final location.

Further, in one embodiment, interface logic 221 may be used to facilitate interfacing between various components of prediction mechanism 110 as well as with other components and/or devices, such as one or more database(s) 140. Similarly, in one embodiment, interface logic 221 may be used to facilitate and support user interface(s) at one or more computing device(s) 130A-N so that any queries associated with processing and deployment of metadata packages may be placed, while its results, may be accessed and/or viewed by users through such user interface(s) at one or more computing device(s) 130A-N. It is contemplated that the one or more interfaces are not limited to any particular number or type of interfaces such that an interface may include (without limitations) any one or more of a user interface (e.g., Web browser, Graphical User Interface (GUI), software application-based interface, etc.), an application programming interface (API), a Representational State Transfer (REST) or RESTful API, and/or the like.

It is contemplated that a tenant may include an organization of any size or type, such as a business, a company, a corporation, a government agency, a philanthropic or non-profit entity, an educational institution, etc., having single or multiple departments (e.g., accounting, marketing, legal, etc.), single or multiple layers of authority (e.g., C-level positions, directors, managers, receptionists, etc.), single or multiple types of businesses or sub-organizations (e.g., sodas, snacks, restaurants, sponsorships, charitable foundation, services, skills, time etc.) and/or the like.

Communication/compatibility logic 207 may facilitate the ability to dynamically communicate and stay configured with any number and type of software/application developing tools, models, data processing servers, database platforms and architectures, programming languages and their corresponding platforms, etc., while ensuring compatibility with changing technologies, parameters, protocols, standards, etc.

It is contemplated that any number and type of components may be added to and/or removed from prediction mechanism 110 to facilitate various embodiments including adding, removing, and/or enhancing certain features. It is contemplated that embodiments are not limited to any particular technology, topology, system, architecture, and/or standard and are dynamic enough to adopt and adapt to any future changes.

FIG. 3A illustrates a transaction sequence 300 for facilitating production and selection of models for generating predictions according to one embodiment. Transaction sequence 300 may be performed by processing logic that may comprise hardware (e.g., circuitry, dedicated logic, programmable logic, etc.), software (such as instructions run on a processing device), or a combination thereof. In one embodiment, transaction sequence 300 may be performed or facilitated by one or more components of model-predictions mechanism 110 of FIGS. 1-2. The processes of transaction sequence 300 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-2 may not be repeated or discussed hereafter.

As described with reference to FIG. 2, feature extractor 213 may be used to provide the first stage in usable or reusable machine learning process by at least putting data into a standard format. For example, feature extractor 213 may operate as an interface between data sources and the machine learning framework described herein. In one embodiment, feature extractor 213 may be used to acquire data in any format and provide data in one of the standard formats supported by the framework.

As illustrated, feature extractor 213 may include data reader 301, feature aggregator 303, and feature getter 305. For example, data reader 301 of feature extractor 213 may operate to load data into the framework, where data reader 301 operates to do simple data manipulation and joining. In one embodiment, complex data joins and/or processing are done in separate extract, transform, load (ETL) jobs, such as data containing the key for what is to be scored when the data is returned. For example:

```
/**
*Reader for data files
*@tparam type of data records
*/
abstract class DataReader[T] extends Serializable {
  def getPath (pathInfo: Map[String, String]): String
  def load(implicit params: WorkflowParams, sc:SparkContext):
RDD[T]
}
```

Similarly, for example, feature aggregator 303 and/or feature getter 305 may be used to operate to define how to turn the data from the record into a standardized feature type. In one embodiment, feature getter 605 may generally operate on flat files. In one embodiment, feature aggregator 303 may define timed events and filters to determine how data is to be combined. For example, feature aggregator 303 may operate on daily, hourly, and/or streamed records. For example:

/**
*The base trait for feature getters and aggregators
*@tparam I input
*@tparam O output
*/
trait TransformerLike[−I, +O] extends Serializable {
def transform(value: I)(implicit params: ExtractorParams): O
}

In one embodiment, feature extractor 213 may take the value for each feature in a row and then place those values in an internal format to be used in transaction sequence 300. In one embodiment, this results in all internal data being in known standard formats regardless of original data source.

Further, in one embodiment, as described with reference to FIG. 2, plan transformer 215 to perform data conversion in one or more stages, such as reading of data, returning of a specific type of data, etc. Events are defined for a data record type, where events are used to extract features for each row. Further, features are combined to give a single feature vector for each entity to be scored.

For example, plan transformer 215 includes feature transformer 307 to provide transformations that can be abstracted and reusable. In one embodiment, feature transformer 307 may operate to map features to features to be used (e.g., Clicks->Log, Data_Joined->Days_Ago), where several types of transformations may be supported, such as mathematical (e.g., log, normalize, cap, etc.), expansion (e.g., pivot, bin, TFIDF, etc.), reduction (e.g., hash, minimum requirements, etc.), combination (e.g., interaction, similarity, etc.), time (e.g., days since, weeks since, occurred on, etc.), and/or the like.

In one embodiment, transformations are defined in a generalizable way, where at a high level, transformations may be defined by an old feature that goes in and a new feature (or sequence) comes out. For example, each transformation may have a unique identifier. Further, transformations may be chained together arbitrarily and run efficiently. Feature transformations, as facilitated by feature transformer 307, may be as simple as applying the same function to a feature value for each row, or more complex that may necessitate a full knowledge of all values for a feature column. For example:

Trait Feature Transformer extends Serializable with Logging {
val featureName: FeatureName
val derivedFeatureName: FeatureName
val inFinalOuput: Boolean
def key: FeatureName=s″$featureName to $derivedFeatureName”

}

Some specific transformations from a transformation plan may include (but not limited to): Clicks->Log; Opens->Log; Opens+Sends->Divide; Clicks+Sends->Divide; SubjectLinesResponsedTo->TFIDF; SubjectLinesNotRespondedTo->TFIDF; SubjectLinesRespondedTo_TFIDF+SubjectLinesNotRespondedTo_TFIDF->Similarity, etc.

As described with reference to FIG. 2, in one embodiment, model selector 217 may be used for selection of a model and may include preparator 309 for preparation of data (such as predications and/or relevant data), sanity checker 311 to check and verify the data, and model fitter 313 to fit the most appropriate model for the tenant. Similarly, as described with reference to FIG. 2, data writer 219 may be triggered to put data in a final format and place it in a final location. The appropriately generated, trained, tuned, and selected model is then shared with or transmitted over to a corresponding tenant so that the tenant may use a single model to know and have predictions relevant to all its customers as opposed to having a team of software developers and data scientists to generate and maintain a separate model for each customer.

FIG. 3B illustrates a transaction sequence 320 for facilitating transformation according to one embodiment. Transaction sequence 320 may be performed by processing logic that may comprise hardware (e.g., circuitry, dedicated logic, programmable logic, etc.), software (such as instructions run on a processing device), or a combination thereof. In one embodiment, transaction sequence 320 may be performed or facilitated by one or more components of model-predictions mechanism 110 of FIGS. 1-3A. The processes of transaction sequence 320 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3A may not be repeated or discussed hereafter.

In the illustrated embodiment, transaction sequence 320 of transformations is generated by mapping over current feature names 321 that need to be transformed, where the result is a new set of features 323 that have been explicitly transformed. In one embodiment, model selector 217 of FIG. 2 may be used to provide a uniform interface for machine learning models. This allows for efficient switching of models. In one embodiment, model selector 217 of FIG. 2 may operate to receive data in a correct format for libraries or models.

FIG. 3C illustrates a transaction sequence 330 for facilitating production and selection of models for generating predictions according to one embodiment. Transaction sequence 330 may be performed by processing logic that may comprise hardware (e.g., circuitry, dedicated logic, programmable logic, etc.), software (such as instructions run on a processing device), or a combination thereof. In one embodiment, transaction sequence 330 may be performed or facilitated by one or more components of model-predictions mechanism 110 of FIGS. 1-3B. The processes of transaction sequence 330 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3B may not be repeated or discussed hereafter.

The illustrated embodiment relates to a declarative type safe syntax including various interchangeable parts for facilitating production and selection of models for generating predictions. In one embodiment, features 331 may be materialized by workflows 339 that receive input data from readers 341, such as data reader 301 of FIG. 3A. In one embodiment, features 331 are transformed with and produced by transformers 335 (such as plan transformer 215 and/or feature transformer 307 of FIG. 3A) and estimators 337 that are fitted into transformers 335.

FIG. 3D illustrates a transaction sequence 350 for facilitating production and selection of models for generating predictions according to one embodiment. Transaction sequence 350 may be performed by processing logic that may comprise hardware (e.g., circuitry, dedicated logic, programmable logic, etc.), software (such as instructions run on a processing device), or a combination thereof. In one embodiment, transaction sequence 350 may be performed or facilitated by one or more components of model-predictions mechanism 110 of FIGS. 1-3C. The processes of transaction sequence 350 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3C may not be repeated or discussed hereafter.

As illustrated with respect to FIG. 3C, this illustration reflects another embodiment of relationships between features 331 (e.g., numeric, text, categorical, etc.) that are transformed with and produced by transformers 335 (e.g., unary, binary, etc.), where estimators 337 (e.g., average, Word2Vec, my model, etc.) are fitted into transformers 335. Further, in one embodiment, readers 341 (e.g., CSV, Avro, etc.) are used for joining and/or aggregating of data, etc., and read into workflows 339 (e.g., titanic, lead scoring, etc.), where workflows 339 are materialized by features 331.

FIG. 3E illustrates a workflow 360 with features according to one embodiment. Workflow 360 may be generated and its functions may be performed by processing logic that may comprise hardware (e.g., circuitry, dedicated logic, programmable logic, etc.), software (such as instructions run on a processing device), or a combination thereof. In one embodiment, workflow 360 may be generated or facilitated by one or more components of model-predictions mechanism 110 of FIGS. 1-3D. The processes of workflow 360 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3D may not be repeated or discussed hereafter.

In the illustrated embodiment, workflow 360 is based on features that point to a column of data, where the types of these features determine which stages can act on them. Some examples of features include (but not limited to) gender, age, name, title, etc., as illustrated.

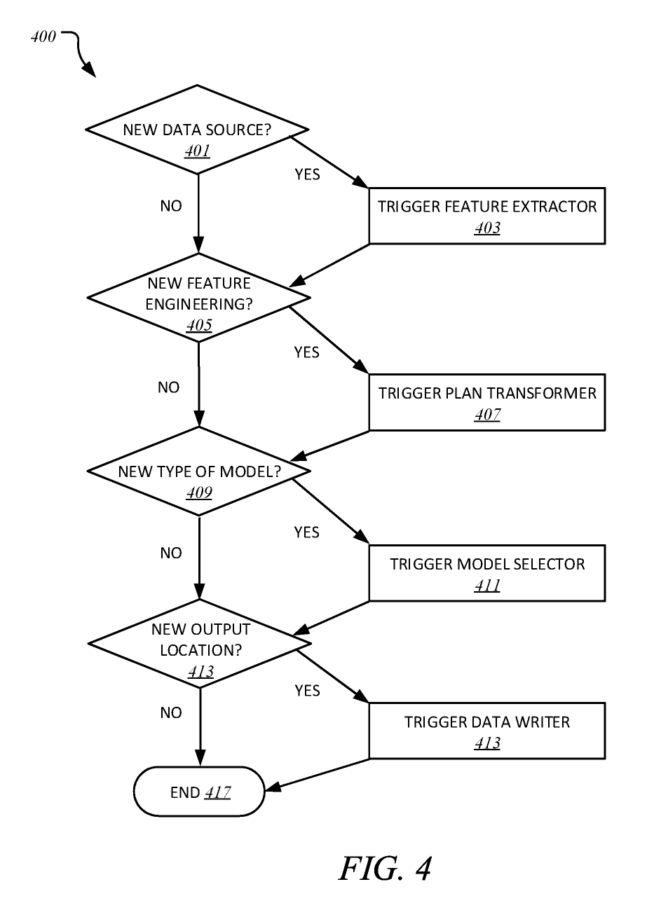

FIG. 4 illustrates a method 400 for facilitating production and selection of models for generating predictions according to one embodiment. Method 400 may be performed by processing logic that may comprise hardware (e.g., circuitry, dedicated logic, programmable logic, etc.), software (such as instructions run on a processing device), or a combination thereof. In one embodiment, method 400 may be performed or facilitated by one or more components of model-predictions mechanism 110 of FIGS. 1-2. The processes of method 400 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3E may not be repeated or discussed hereafter.

Method 400 begins at block 401 with a determination as to whether there is a new data source. If there is a new data source, feature extractor, such as feature extractor 213, is triggered at block 403 to perform one or more of the operations described with reference to FIGS. 2 and 3A. If there is no new data source or after triggering feature extractor at block 403, another determination is made at block 405 as to whether new feature engineering is being experienced. If there is new feature engineering, feature transformer, such as feature transformer 307 of plan transformer 215, is triggered at block 407 to perform one or more of the operations described with reference to FIGS. 2 and 3A. However, if there is no new feature engineering or upon triggering feature transformer at block 407, method 400 continues with block 409 with another determination as to whether there is a new type of model.

In one embodiment, if there is a new type of model, model selector, such as model selector 217, is triggered at block 411 to perform one or more of the operations described with reference to FIGS. 2 and 3A. If, however, there is no new type of model or that model selector has been triggered at block 411, another determination is made at block 413 as to whether there is a new output location. If yes, data writer, such as data writer 219, is triggered at block 415 to perform one or more of the operations described with reference to FIGS. 2 and 3A. If not, method 400 is terminated at block 417.

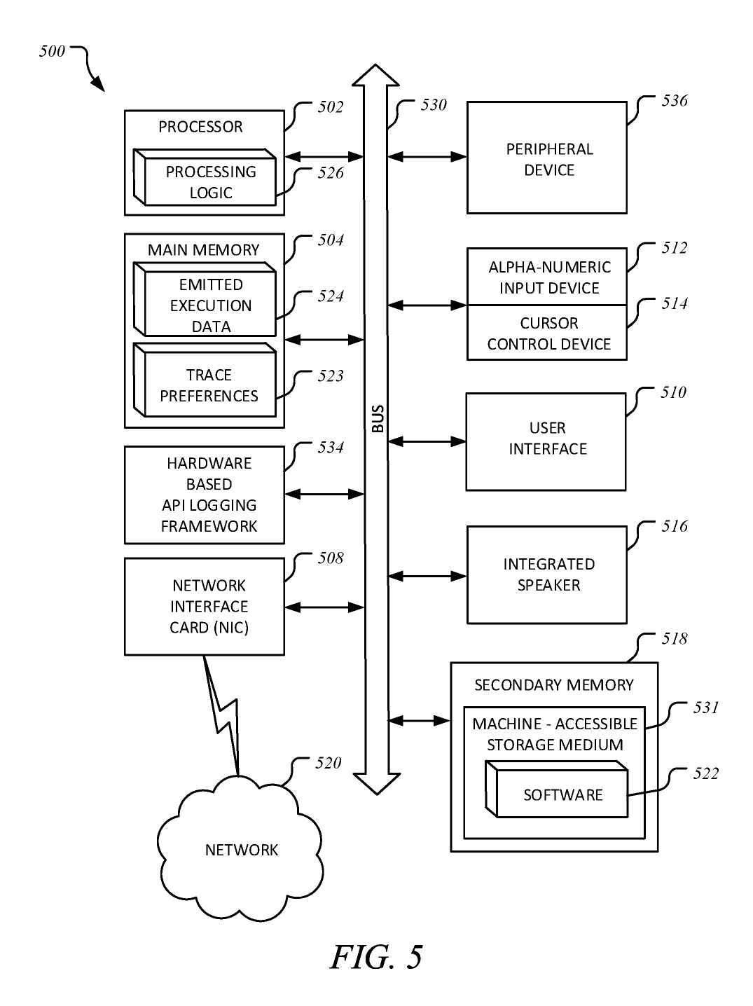

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. Machine 500 is the same as or similar to computing devices 120, 130A-N of FIG. 1. In alternative embodiments, the machine may be connected (e.g., networked) to other machines in a network (such as host machine 120 connected with client machines 130A-N over network(s) 135 of FIG. 1), such as a cloud-based network, Internet of Things (IoT) or Cloud of Things (CoT), a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes emitted execution data 524 (e.g., data emitted by a logging framework) and one or more trace preferences 523 which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of query mechanism 110 as described with reference to FIG. 1 and other Figures discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc. The computer system 500 may further include a Hardware based API logging framework 534 capable of executing incoming requests for services and emitting execution data responsive to the fulfillment of such incoming requests.

The secondary memory 518 may include a machine-readable storage medium (or more specifically a machine-accessible storage medium) 531 on which is stored one or more sets of instructions (e.g., software 522) embodying any one or more of the methodologies or functions of query mechanism 110 as described with reference to FIG. 1, respectively, and other figures discussed herein. The software 522 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508. The machine-readable storage medium 531 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

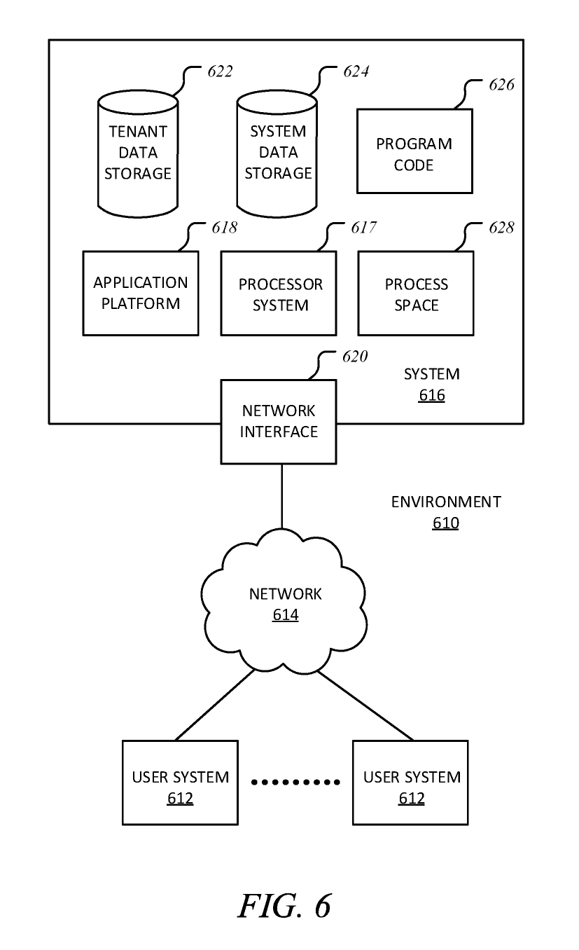

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

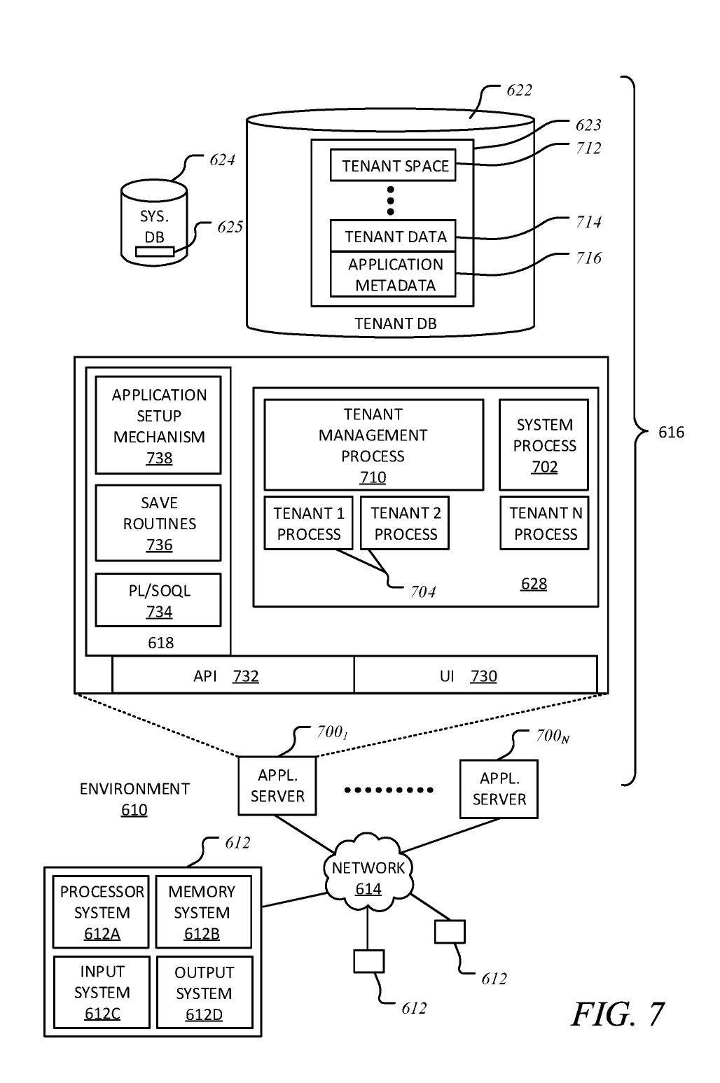

Environment 610 is an environment in which an on-demand database service exists. User system 612 may be any machine or system that is used by a user to access a database user system. For example, any of user systems 612 can be a handheld computing device, a mobile phone, a laptop computer, a workstation, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third-party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load-sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third-party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database-indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. User system 612 further includes Mobile OS (e.g., iOS® by Apple®, Android®, WebOS® by Palm®, etc.). Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™ JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers’ creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users’ data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A method comprising:
collecting, by a model selection and application server device (“model device”), information associated with customers of a tenant;
extracting, from the information, behavior traits of the customers as they relate to products or services offered by the tenant;
dynamically selecting, by the model device, a single model from a set of models to convert the behavior traits into predictions indicating anticipated conduct of each customer in relation to one or more products or one or more of the services of the tenant, wherein the single model performs multiple processes to convert the behavior traits into predictions, wherein the multiple processes include at least two of the following: evaluating data, cleansing the data, transforming the data, and writing the data; and
transmitting, over a communication medium, the predictions to the tenant.

2. The method of claim 1, where collecting comprises accessing data from one or more databases such that the data includes the information and other relevant features associated with the customers, wherein the data is received from the customers over a period of time and stored at the one or more databases.

3. The method of claim 1, wherein the behavior traits comprise habitual or customary acts of the customers, wherein a behavior trait indicates a likelihood of a future act of a customer such that the behavior trait is converted into a prediction.

4. The method of claim 1, wherein the single model to server the customers for the tenant, wherein the multiple processes are performed for each of the customer of the tenant.

5. The method of claim 1, wherein the predictions include one or more sets of predictions corresponding to one or more customers of the customers such that each set of predictions anticipates future actions of its corresponding customer, wherein the future actions are in reference to the one or more products or the one or more services of the tenant.

6. The method of claim 5, further comprising facilitating, by one or more display devices, viewing of the predictions at one or more computing devices accessible to the tenant, wherein the predictions are used for generating or modifying business plans for the tenant.

7. A database system comprising:
a model selection and application server device having memory coupled to a processing device, the processing device to execute instructions to perform operations comprising:
collecting, by a model selection and application server device (“model device”), information associated with customers of a tenant;
extracting, from the information, behavior traits of the customers as they relate to products or services offered by the tenant;
dynamically selecting, by the model device, a single model from a set of models to convert the behavior traits into predictions indicating anticipated conduct of each customer in relation to one or more products or one or more of the services of the tenant, wherein the single model performs multiple processes to convert the behavior traits into predictions, wherein the multiple processes include at least two of the following: evaluating data, cleansing the data, transforming the data, and writing the data; and
transmitting, over a communication medium, the predictions to the tenant.

8. The system of claim 7, where collecting comprises accessing data from one or more databases such that the data includes the information and other relevant features associated with the customers, wherein the data is received from the customers over a period of time and stored at the one or more databases.

9. The system of claim 7, wherein the behavior traits comprise habitual or customary acts of the customers, wherein a behavior trait indicates a likelihood of a future act of a customer such that the behavior trait is converted into a prediction.

10. The system of claim 7, wherein the single model to server the customers for the tenant, wherein the multiple processes are performed for each of the customer of the tenant.

11. The system of claim 7, wherein the predictions include one or more sets of predictions corresponding to one or more customers of the customers such that each set of predictions anticipates future actions of its corresponding customer, wherein the future actions are in reference to the one or more products or the one or more services of the tenant.

12. The system of claim 11, wherein the operations further comprise facilitating, by one or more display devices, viewing of the predictions at one or more computing devices accessible to the tenant, wherein the predictions are used for generating or modifying business plans for the tenant.

13. A machine-readable medium comprising a plurality of instructions which, when executed by a processing device, cause the processing device to perform operations comprising:
collecting, by a model selection and application server device (“model device”), information associated with customers of a tenant;
extracting, from the information, behavior traits of the customers as they relate to products or services offered by the tenant;
dynamically selecting, by the model device, a single model from a set of models to convert the behavior traits into predictions indicating anticipated conduct of each customer in relation to one or more products or one or more of the services of the tenant, wherein the single model performs multiple processes to convert the behavior traits into predictions, wherein the multiple processes include at least two of the following: evaluating data, cleansing the data, transforming the data, and writing the data; and
transmitting, over a communication medium, the predictions to the tenant.

14. The machine-readable medium of claim 13, where collecting comprises accessing data from one or more databases such that the data includes the information and other relevant features associated with the customers, wherein the data is received from the customers over a period of time and stored at the one or more databases.

15. The machine-readable medium of claim 13, wherein the behavior traits comprise habitual or customary acts of the customers, wherein a behavior trait indicates a likelihood of a future act of a customer such that the behavior trait is converted into a prediction.

16. The machine-readable medium of claim 13, wherein the single model to server the customers for the tenant, wherein the multiple processes are performed for each of the customer of the tenant.

17. The machine-readable medium of claim 13, wherein the predictions include one or more sets of predictions corresponding to one or more customers of the customers such that each set of predictions anticipates future actions of its corresponding customer, wherein the future actions are in reference to the one or more products or the one or more services of the tenant.

18. The machine-readable medium of claim 17, wherein the operations further comprise facilitating, by one or more display devices, viewing of the predictions at one or more computing devices accessible to the tenant, wherein the predictions are used for generating or modifying business plans for the tenant.
